(19) United States
(12) Patent Application Publication
(10) Pub. No.: US 2007/0274802 A1
(43) Pub. Date: Nov. 29, 2007

(54) Injection Fixing Arrangement And Method Of Injection Fixing

(75) Inventors: Rainer Jakob, Freiburg (DE); Ralph Berg, Freiburg (DE)

Correspondence Address: MICHAEL J. STRIKER, 103 EAST NECK ROAD, HUNTINGTON, NY, 11743, US

(73) Assignee: FISCHERWERKE ARTUR FISCHER GMBH& CO., KG, WALDACHTAL GERMANY (DE)

(21) Appl. No.: 11/568,693

(22) PCT Filed: May 21, 2005
(86) PCT No.: PCT/EP05/05532

§ 371 Date: Nov. 3, 2006

(30) Foreign Application Priority Data
Jun. 16, 2004 (DE) 10-2004-029-018.0

(51) Int. Cl. F16B 13/06

(52) U.S. Cl. 411/55

(57) ABSTRACT

The invention relates to an injection fixing arrangement (1) having an anchor sleeve (5) and an anchor rod (6), the anchor sleeve (5) having an anchoring region (9) with outlet apertures (10) for the outlet of mortar injected into the anchor sleeve (5), and the injection fixing arrangement (1) having a nut (7) as abutment for the article (2) being fixed. Injection fixing arrangements (1) of such a kind for proud-standing mounting are known. The invention proposes an injection fixing arrangement (1) for push-through mounting, wherein a transverse-force sleeve (11) follows the anchoring region (9) of the anchor sleeve (5).

The invention relates to an injection fixing arrangement having the features of the preamble of claim 1 and to a method of injection fixing having the features of the preamble of claim 8. Injection fixing in this context means the anchoring of an anchor rod, for example, using mortar in a hole drilled in masonry.

Fixing by means of injection fixing arrangements has been known for a long time. A hole is drilled in an anchoring substrate, for example masonry comprising void-containing building materials. An anchor sleeve as known, for example, from the publication DE 201 05 013.7 is introduced into that drilled hole. The known anchor sleeve is in the form of a mesh sleeve having mesh holes, which is made, for example, of plastics material. After introduction into the masonry, mortar is injected into the anchor sleeve, passing out through the mesh holes of the anchor sleeve. The anchor rod is subsequently introduced into the anchor sleeve. It displaces and compacts the mortar and, once the mortar has hardened, is anchored in the bore in the masonry. The article being fixed is mounted on the anchor rod and fixed using a nut, and where appropriate a washer, as abutment.

The known anchor sleeves have the disadvantage that they are suitable only for so-called “proud-standing mounting”. This means that, as a first step in the mounting procedure, the positions of the anchoring points are marked on the anchoring substrate. This can mean, for example, that a particular configuration of holes in an article to be fixed has to be transferred to the masonry. In the second step, the hole is drilled; the anchor is then installed and finally the article being fixed is guided onto the anchor rod and secured using a nut. However, the transfer to the anchoring substrate can be very time-consuming, especially in the case of articles having three or more anchoring points. In the field of plastic fixing plugs and of metal anchors which are anchored by means of expanding forces, types of fixing plug which allow so-called “push-through mounting” have become established in the market-place. In that case, the holes of the article being fixed are used as a drilling template, because the diameter of the drilled hole in the component being connected is at least the same size as that in the anchoring substrate. The fixing plug can be installed directly through the article, and expanded, without once more taking the article away from the anchoring substrate. However, a mounting sequence of such a simplified kind has not hitherto been possible for injection fixing using anchor sleeves.

Anchor sleeves for push-through mounting are known only where two anchoring regions are provided. Accordingly, there is known, for example, from the publication DE 100 38 801 A1, an anchor sleeve for safeguarding facing masonry. The known anchor sleeve has a first anchoring region which has outlet apertures for the mortar. Anchoring of the anchor rod in the supporting masonry is accomplished by means of that first anchoring region. Following that first anchoring region in the direction opposite to the direction of introduction of the anchor sleeve is a tubular part. The function of that tubular part is merely to provide a communicating channel for the injected mortar between the first anchoring region and the second anchoring region of the fixing arrangement. The second anchoring region, which is located in the facing masonry, is produced solely by the anchor rod and the mortar. The tubular part of the anchor sleeve projects only a small way into the facing masonry, whereas the anchor rod projects further out from the sleeve and is surrounded by mortar. However, after installation has been completed, neither the anchor rod nor the mortar project out from the masonry, which is desirable for visual reasons. If it is at all possible to refer to the facing masonry as an article being fixed, it is not fixed by means of an abutment in the form of a nut which exerts a mechanical action but rather by means of a second chemical bond like that in the supporting masonry. However, a second chemical bond of such a kind presupposes that the article being fixed is sufficiently wide to allow stable bonding with mortar. This is generally not the case when, for example, the article being fixed is made from steel and has a flange.

The invention is accordingly based on the problem of achieving a simplification of the installation procedure in the case of such injection fixings where fixing of the article to be fixed is accomplished using a nut as abutment.

In accordance with the invention, the problem is solved by the injection fixing arrangement having the features of claim 1 and by the method having the features of claim 8. The injection fixing arrangement according to the invention has an anchor sleeve whose anchoring region is followed by a transverse-force sleeve. An anchor sleeve of such a kind provides the possibility of producing an injection fixing, with securing of the article by a nut, by means of push-through mounting. As a result of the provision of a transverse-force sleeve it becomes possible for the hole drilled in the anchoring substrate and the hole drilled in the article being fixed to have the same diameter. The hole in the anchoring substrate can be drilled through the hole drilled in the article and the anchor sleeve can then be introduced into the drilled hole directly without removing the article. Mortar is then injected into the anchor sleeve, some of it passing out through the mesh holes of the anchor sleeve. The anchor rod is introduced into the anchor sleeve and as a result is anchored at least in the anchoring region of the anchor sleeve after the mortar has fully hardened. The article being fixed is pushed onto the anchor rod and is fixed by means of a nut, and where appropriate a washer, as abutment. Because the anchor rod in this procedure necessarily has a smaller diameter than the hole drilled in the article, it is not capable, in the case of transverse forces between the article and the anchoring substrate, of taking up such movements on its own. However, this is achieved in accordance with the invention by means of the transverse-force sleeve, the external diameter of which advantageously corresponds to the diameter of the hole drilled in the article.

In order to be able to use the injection fixing arrangement for articles of different thicknesses, the invention also proposes that the transverse-force sleeve of the anchor sleeve have at least one intended separation location. This makes it possible for the user to match the anchor sleeve to the thickness of the article in the course of installation, by shortening the transverse-force sleeve where appropriate. An intended separation location is to be understood as a structure which makes possible deliberate, simple breaking-off or separation in any another way and is, especially, a circumferential notch. However, also feasible in principle are perforations or locally weakened regions resulting from modification of the composition of the material. In this context it is immaterial whether separation at the intended separation location is carried out with or without use of a tool or whether the separation involves breaking, or whether a notch merely serves, for example, to make a cut easier to carry out. What is material, however, is that the user is assisted in shortening the transverse-force sleeve to the desired length.

After it has been introduced into the drilled hole, the anchor sleeve should extend within the anchoring substrate and in the article so that the end remote from the drilled hole finishes flush with the outside of the article. Injection of the mortar or introduction of the anchor rod should not cause this axial position to change. Preferably, therefore, the anchor sleeve has a stop collar at its opposite end to the direction of introduction. If the length of the transverse-force sleeve does not need to be modified to suit a thin article, the anchor sleeve is introduced into the drilled hole until the stop collar comes to rest against the article and is accordingly prevented from being pushed in further. If the length of the transverse-force sleeve does have to be modified—with or without the aid of an intended separation location—the anchor sleeve preferably has at least one stop which can be folded radially inwards. It is advantageous if a plurality of stops distributed around the periphery are in each case arranged in the region of an intended separation location, the stops projecting out radially beyond the transverse-force sleeve in the state prior to anchoring. On introduction of the anchor sleeve into the drilled hole, the anchor sleeve first comes to rest against the stop axially closest to the anchoring region. If the length of the anchor sleeve has been modified beforehand to suit this anchoring depth, the anchor sleeve remains in that position and the stop serves to secure the axial position in the same manner as already described for the stop collar. If, however, the length of anchor sleeve has not been modified at all or if it has been modified at another location, the stop can be folded radially inwards, for which a certain force is necessary. This means that the stop is so joined to the transverse-force sleeve that even though it can withstand the forces occurring during injection of the mortar or during introduction of the anchor rod without being folded, the stability of the joint is such that, in the case of somewhat higher forces, it acts like a hinge. Radially inwards is understood to mean that there no longer is, at least, any substantial radial projection out from the transverse-force sleeve, the stop accordingly being, for example, flush with the external contour of the transverse-force sleeve. Without departing from the idea of the invention, the stops can also be broken off or displaced instead of being folded. The sole material point is that they can act as stops although this action can be negated. On further introduction of the anchor sleeve into the drilled hole, several stops can be overcome in this manner until the end which is remote from the drilled hole, having a stop or a stop collar, comes into abutment.

Alternatively to stops which can be folded inwards, the anchor sleeve can have an axially adjustable stop collar. The axial adjustability can be produced by an additional part which can be brought into different axial positions, for example by means of a screw thread or latching devices, and readily fixed at least therein. Besides that, it would also be possible to provide the anchor sleeve itself with axial flexibility, for example by formation of a concertina-like region. This too would bring about adjustability of the stop collar in the axial direction.

The transfer of transverse forces between the article to be fixed and the substrate can be accomplished solely by means of the transverse-force sleeve. In order to be able to transfer especially high forces, there is injected into the anchor sleeve an amount of mortar which is sufficient also to fill the annular gap between the anchor rod and the inside of the transverse-force sleeve. As a result, once the mortar has hardened, the transverse forces can also be transferred by way of that shell of mortar and the anchor rod. However, especially in the case of relatively small anchor rod diameters, considerable amounts of mortar are required for the purpose in some cases. The invention accordingly further proposes that a compensating sleeve be introduced into the region between the anchor rod and the transverse-force sleeve. This compensating sleeve can be made from plastics material but also from die-cast zinc or the like. It replaces the mortar in that region and, as a result, makes the injection fixing arrangement more economical and shortens the injection procedure. The compensating sleeve can be in the shape of a circular tube, that is to say, for example, having a constant wall thickness around its circumference, but preferably it is not circular and has axially extending flutes. By that means it can adapt to suit different anchor rod diameters. Whereas in the case of anchor rods of small diameter, for example, it assumes an approximately square cross-section and by that means centres the anchor rod inside the transverse-force sleeve, it can adapt, in the case of anchor rods of large diameter, to form an almost circular cross-section.

The invention will be explained in greater detail hereinbelow with reference to an exemplary embodiment shown in the drawings, in which:

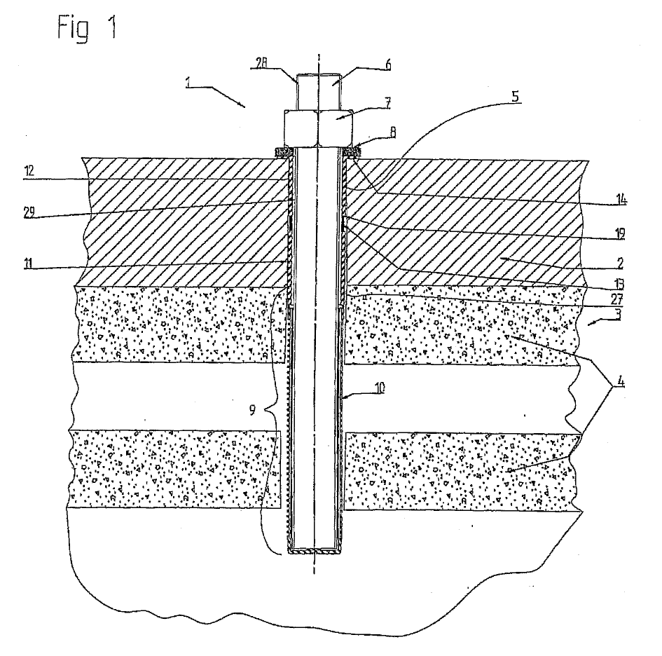

FIG. 1 is a sectional view of the injection fixing arrangement, having an anchor sleeve that has been shortened to the desired length, in the completely installed state;

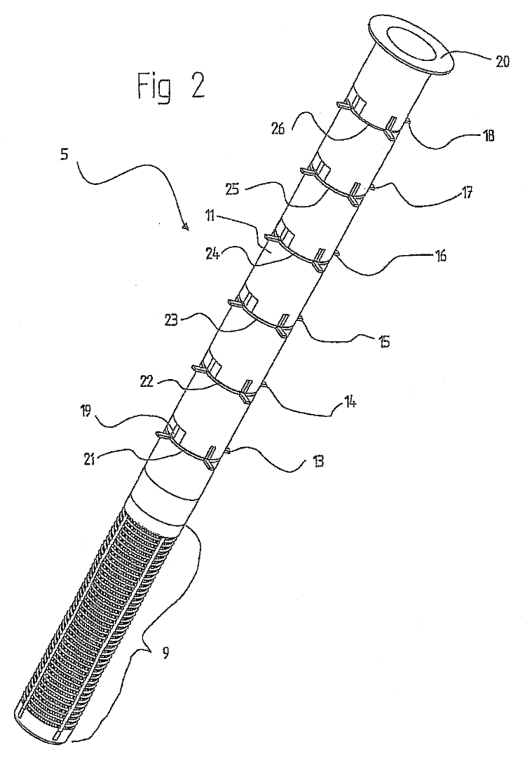

FIG. 2 is a perspective view of the anchor sleeve of the same injection fixing arrangement in the state prior to installation;

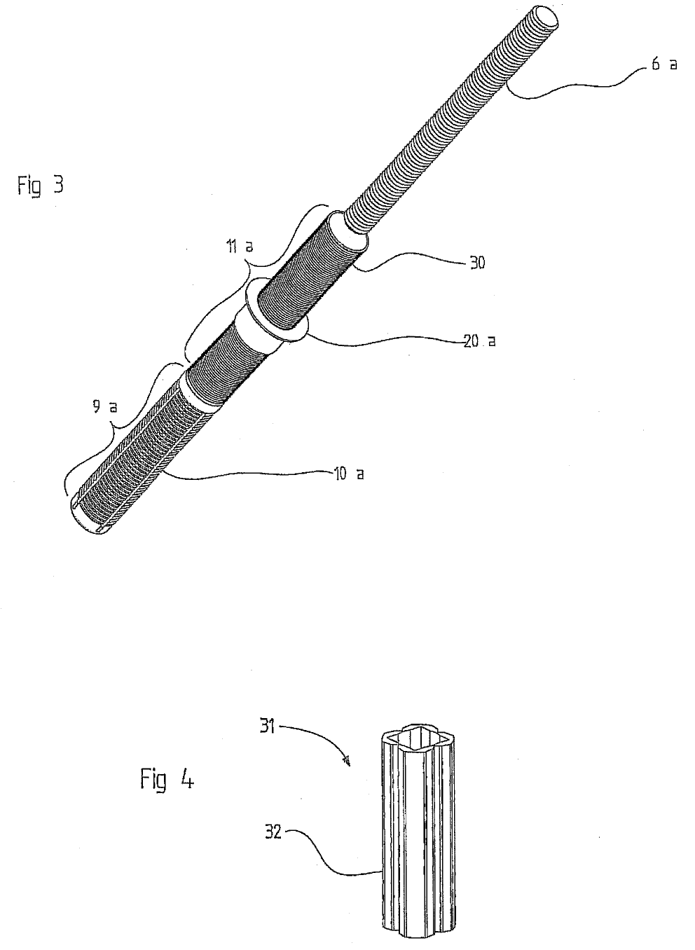

FIG. 3 is a perspective view of an alternative anchor sleeve, together with an anchor rod, in the state prior to installation; and

FIG. 4 shows a compensating sleeve.

The injection fixing arrangement 1 shown in FIG. 1 is used for fixing the article 2 to an anchoring substrate 3 comprising building materials having voids and solid regions 4. To provide a clear view, the completely installed state is shown without mortar. The injection fixing arrangement 1 consists of an anchor sleeve 5, an anchor rod 6, a nut 7 as abutment for the article 2, and a washer 8. The anchor sleeve 5 has an anchoring region 9 having outlet apertures 10 for the injected mortar. Following the anchoring region 9 is a substantially enclosed transverse-force sleeve 11. The external diameter of the transverse-force sleeve 11 corresponds substantially to the diameter of the hole 12 drilled in the article 2. In the region of the transverse-force sleeve 11, there are arranged at each of two locations tongue-shaped stops 13, 14 which are arranged in a ring formation around the periphery of the transverse-force sleeve 11 and which can be folded radially inwards. The folding capability arises solely out of the small cross-sectional area by which the stops 13, 14 are joined to the transverse-force sleeve 11. This effect could be reinforced by notches or the like. The stops 13 arranged inside the drilled hole 12 have been folded in into recesses 19, whereas the stops 14 are in fact used as stops.

FIG. 2 shows the anchor sleeve 5 before installation and not having had its length shortened. Following the anchoring region 9 is the transverse-force sleeve 11 having six rings of stops 13 to 18 and also a stop collar 20. The stops 13 to 18 can in each case be folded into recesses 19. In the present exemplary embodiment, the recesses 19 extend all the way through the transverse-force sleeve 11, but they could also be closed off on the inside by a very thin injection-moulded skin in order to prevent the possibility of mortar escaping. With each ring of stops 13 to 18 there is associated a circumferential intended separation location 21 to 26 in the form of a circumferential notch.

The installation procedure is described hereinbelow with reference to both FIGS. 1 and 2. First, a hole 12 and 27 is drilled both in, respectively, the article 2 (unless already provided) and in the anchoring substrate 3. This can be done in such a way that the article 2 is put in place against the anchoring substrate 3 in the desired position and the hole 12 and 27 is drilled through the article 2. Beforehand or alternatively afterwards, the length of the anchor sleeve 5 is modified to suit the thickness of the article 2, that is to say in the present case it is broken off at the intended separation location 22. The anchor sleeve 5 is then pushed through the drilled hole 12 in the article 2 and into the drilled hole 27 in the anchoring substrate 3. In the course of introduction, the stops 13 first come up against the article 2. As a result of pushing somewhat more firmly on the anchor sleeve 5, the stops 13 fold radially inwards and the anchor sleeve 5 can be pushed into the drilled holes 12 and 27 until the stops 14 come into abutment. Subsequently, mortar is injected into the anchoring region 9 of the anchor sleeve 5. As a result of introduction of the anchor rod 6 into the anchor sleeve 5, the mortar is displaced and, as a result, flows both out of the outlet apertures 10 and also, in part, into the transverse-force sleeve 5. In the process, the stops 14 prevent the anchor sleeve 5 from moving further into the anchoring substrate 3. As a result of coming out of the outlet apertures 10, the mortar in the hardened state forms a very good association with the anchoring substrate 3 and with the anchor rod 6 both as a result of its bonding action and also as a result of engagement behind the solid regions 4 and the thread 28 of the anchor rod 6. In order to fix the article 2 subsequently, the washer 8 is pushed onto the anchor rod 6 and the nut 7 is screwed up on the thread 28 and tightened. Should transverse force stressing occur between the article 2 and the anchoring substrate 3, this can be taken up by the transverse-force sleeve 5. This possibility is improved if the intermediate space 29 between the transverse-force sleeve 5 and the anchor rod 6 is at least partly filled with mortar, because the anchor rod 6 can then also transfer some of the transverse forces.

FIG. 3 shows a variant of the anchor sleeve 5a, which likewise has an anchoring region 9a having outlet apertures 10a and a transverse-force sleeve 11a. In contrast to the anchor sleeve 5 shown in FIGS. 1 and 2, the stop collar 20a is axially adjustable. It is in the form of a separate part having an internal thread which corresponds to an external thread 30 on the transverse-force sleeve 11a. For the purpose of installation of the injection fixing arrangement, the stop collar 20a is adjusted to suit the thickness of the article by rotation and then that part of the transverse-force sleeve 11a which projects beyond the stop collar 20a is cut off. Again, the anchor sleeve 5a is then pushed through the drilled hole in the article and into the drilled hole in the anchoring substrate.

As is made clear, for example, in FIG. 3, the anchor rod 6a can have an external diameter which is much reduced compared to the diameter of the transverse-force sleeve 11a. In order to fill the region between the anchor rod 6a and the inside of the transverse-force sleeve 11a for the purpose of transferring transverse forces, that region can either also be filled with mortar or a compensating sleeve 31 corresponding to FIG. 4 can be introduced. The compensating sleeve 31 has a substantially constant cross-section over its length, but this is not imperative. It is accordingly tubular, but not circular with a wall thickness that is constant over its circumference; rather it is approximately square, having flutes 32 in the form of axially extending recesses.

In the case of small anchor rod diameters, the compensating sleeve 31 can be introduced in that form into the transverse-force sleeve 11a and then mortar is injected and the anchor rod 6a introduced, although those steps can also be carried out in another sequence. The volume between the anchor rod 6a and the inside of the transverse-force sleeve 11a which has to be filled by mortar is reduced by the volume of the compensating sleeve 31. This saves mortar and time when injecting the mortar. In addition, the compensating sleeve 31 has the function of centring the anchor rod 6a within the transverse-force sleeve 11a, which brings about uniform introduction of forces into the substrate and, as a result, high holding values. In the case of relatively large anchor rod diameters, the cross-section of the compensating sleeve 31 can approximate more to a circular shape by virtue of deformation at the flutes 32. The transverse-force sleeve 31 is accordingly also suitable for relatively large anchor rod diameters and still performs the function of filling the volume of the annular gap and centring the anchor rod 6a within the transverse-force sleeve 11a.

1. Injection fixing arrangement (1) having an anchor sleeve (5, 5a) and an anchor rod (6, 6a), the anchor sleeve (5, 5a) having an anchoring region (9, 9a) with outlet apertures (10, 10a) for the outlet of mortar injected into the anchor sleeve (5, 5a), and the injection fixing arrangement (1) having a nut (7) as abutment for the article (2) to be fixed, characterised in that a transverse-force sleeve (11, 11a) follows the anchoring region (9, 9a) of the anchor sleeve (5, 5a).

2. Injection fixing arrangement according to claim 1, characterised in that the transverse-force sleeve (11) of the anchor sleeve (5) has at least one intended separation location (21 to 26).

3. Injection fixing arrangement according to claim 1, characterised in that the transverse-force sleeve (11) has a stop collar (20) at its end which is remote from the anchoring region (9).

4. Injection fixing arrangement according to claim 1, characterised in that the transverse-force sleeve (11) of the anchor sleeve (5) has at least one stop (13 to 18) which is foldable radially inwards; and in that the stop (13 to 18) projects radially out beyond the transverse-force sleeve (11) in the state prior to anchoring.

5. Injection fixing arrangement according to claim 1, characterised in that the transverse-force sleeve (11a) of the anchor sleeve (5a) has an axially adjustable stop collar (20a).

6. Injection fixing arrangement according to claim 1, characterised in that between the anchor rod (6, 6a) and the transverse-force sleeve (11, 11a) there is arranged a compensating sleeve (31).

7. Injection fixing arrangement according to claim 6, characterised in that the compensating sleeve (31) has axially extending flutes (32).

8. Method of injection fixing using an anchor sleeve (5, 5a), an anchor rod (6, 6a) and a nut (7) as abutment for the article (2) being fixed, especially in accordance with claim 1, characterised in that in that the mounting is carried out as push-through mounting.
